(19) United States
(12) Patent Application Publication
(10) Pub. No.: US 2023/0352950 A1
(43) Pub. Date: Nov. 2, 2023

(54) ENERGY SUPPLY CIRCUITS

(71) Applicant: Nordic Semiconductor ASA, Trondheim (NO)

(72) Inventor: Philip CORBISHLEY, Trondheim (NO)

(73) Assignee: Nordic Semiconductor ASA, Trondheim (NO)

(21) Appl. No.: 18/029,433

(22) PCT Filed: Oct. 4, 2021
(86) PCT No.: PCT/EP2021/077280

§ 371 Date: Mar. 30, 2023

(30) Foreign Application Priority Data
Oct. 2, 2020 (GB) 2015689.9

(51) Int. Cl. H02J 7/00; H01M 10/48; H01M 10/42; H02J 50/00

(52) U.S. Cl. CPC H02J 7/00308; H01M 10/48; H01M 10/425; H02J 50/001; H02J 2207/20

(57) ABSTRACT

A circuit portion is provided which includes an energy harvesting device producing a DC output; an inductor-less capacitor-based DC-DC converter, having an input connected to the DC output of the energy harvesting device; an output connected to a battery; and a voltage limiting module. The voltage limiting module includes a voltage sensor arranged to measure a voltage representative of a voltage at the battery and is arranged to limit a voltage provided by the DC-DC converter if the voltage representative of the voltage at the battery exceeds a threshold.

The present invention relates to energy supply circuits for energy harvesting devices.

Energy harvesters convert ambient energy from the surrounding environment into a low power voltage supply. Sources of this ambient energy include light sources, thermal sources, kinetic sources (e.g. vibrations) and RF radiation.

An energy harvesting device typically acts as a power supply for a load. They often generate a small energy output, and as such, are typically suited to low-power applications. A load that receives power from an energy harvesting device, in principle, could be any suitable small system or device which consumes power—e.g. IoT sensors, remote sensors, wearables, implantables, smoke detectors etc.

An energy harvesting device is typically connected to a load via a DC-DC converter circuit. The DC-DC converter circuit changes the voltage and at its output can provide power to the load. However the Applicant has appreciated that this presents challenges in certain applications because the voltage derived from an energy harvesting device may be unstable.

The present invention aims at least partially to address this and when viewed from a first aspect provides a circuit portion comprising:
an energy harvesting device producing a DC output;
   an inductor-less capacitor-based DC-DC converter, having an input connected to said DC output of the energy harvesting device;
   an output connected to a battery;
   a voltage limiting module, comprising a voltage sensor arranged to measure a voltage representative of a voltage at the battery;
   wherein the voltage limiting module is arranged to limit a voltage provided by the DC-DC converter if said voltage representative of the voltage at the battery exceeds a threshold.

Thus it will be seen by those skilled in the art that, in accordance with the invention, a voltage limiting module can prevent the circuit portion from supplying the battery with a voltage exceeding threshold, e.g. a maximum safe voltage to prevent damage. The Applicant has appreciated that this enables an inductor-less capacitor-based DC-DC converter to be used which does not regulate its output voltage. It has further appreciated that is desirable to employ such a DC-DC converter in an energy harvesting supply circuit. For example, using an inductor-less DC-DC converter may have the advantage of reducing the size of the circuit as inductors are bulky and expensive components. They may also undesirably interact with a receiver provided on the device due to switching in the MHz range. In accordance with the invention however an inductor-less capacitor-based DC-DC converter, e.g. a switched capacitor DC-DC converter, can be used to charge a battery safely because the voltage limiting module can protect the battery from potential damage caused by a voltage supply that is too high. In this way, the output voltage of the DC-DC converter can, in preferred embodiments, be limited below the termination voltage whilst being within 1% of the termination voltage. This may allow the battery, e.g. a Lithium-Ion battery, to be fully recharged without sustaining any damage. The inclusion of an inductor-less DC-DC converter may also reduce the cost and size of the circuit.

In a set of embodiments, the inductor-less capacitor-based DC-DC converter comprises a plurality of capacitors. This may have the advantage of boosting the voltage and improving the efficiency of the DC-DC converter.

In a set of embodiments, the circuit portion further comprises a monitoring module arranged to monitor an output current of the DC-DC converter and to adjust one or more parameters of the DC-DC converter based on information relating to the DC-DC converter output current. In a set of embodiments the monitoring module is arranged to derive the information relating to the DC-DC converter output current by measuring current through a sense arrangement. The sense arrangement could comprise a resistor or other ohmic element, but in a set of embodiments comprises a non-ohmic semiconductor element. In a set of embodiments, the adjustable parameters of the DC-DC converter comprise frequency and/or input impedance.

In a set of embodiments, the monitoring module is a Maximum Power Point Tracking (MPPT) module.

In a set of embodiments, the voltage limiting module further comprises a switch between the DC-DC converter and the battery. The switch may be arranged to be opened or closed based on a measurement obtained by the voltage sensor. For example, the switch may be arranged to be closed if the voltage measured by the voltage sensor is above the threshold voltage. The voltage sensor may comprise a comparator with a first input comprising the voltage representing the voltage at the battery and a second input comprising a reference voltage.

In a set of embodiments, the DC-DC converter comprises an oscillator which determines an operating frequency of the DC-DC converter. The monitoring module may be arranged to adjust the operating frequency by controlling the oscillator. In a set of embodiments, the voltage limiting module is configured to reduce the frequency of the DC-DC converter based on a measurement obtained by the voltage sensor. In a set of embodiments, the frequency of the DC-DC converter is reduced if the voltage measured at the voltage sensor is above the threshold voltage.

In a set of embodiments, the voltage limiting module is configured to halt operation of the DC-DC converter if the voltage measured by the voltage sensor is above the threshold voltage.

In a set of embodiments the circuit portion comprises a by-pass circuit arranged to by-pass the battery. In a set of such embodiments the by-pass circuit is arranged to route current from the energy harvesting device or the DC-DC converter to ground if the voltage measured by the voltage sensor is above the threshold voltage. In a set of embodiments the by-pass circuit comprises a switch between the output of the energy harvesting device and the input of the DC-DC converter or between the output of the DC-DC converter and the battery and arranged selectively to connect the output of the energy harvesting device or the output of the DC-DC converter respectively to ground.

In a set of embodiments, the circuit portion comprises one or more load switches, each load switch providing a connection to the or a respective load.

In a set of embodiments, e.g. where there are a plurality of loads as mentioned above, the circuit portion comprises two or more power paths. In a set of such embodiments where a current monitoring module is provided the monitoring module is configured to monitor a sum of the currents for the two or more power paths. For example, a first power path may be connected to a battery and a second power path may be connected to a functional system e.g. a module forming part of a wearable device.

Features of any aspect or embodiment described herein may, wherever appropriate, be applied to any other aspect or embodiment described herein. Where reference is made to different embodiments, it should be understood that these are not necessarily distinct but may overlap.

An embodiment of the invention will now be described, by way of example only, with reference to the accompanying drawings in which:

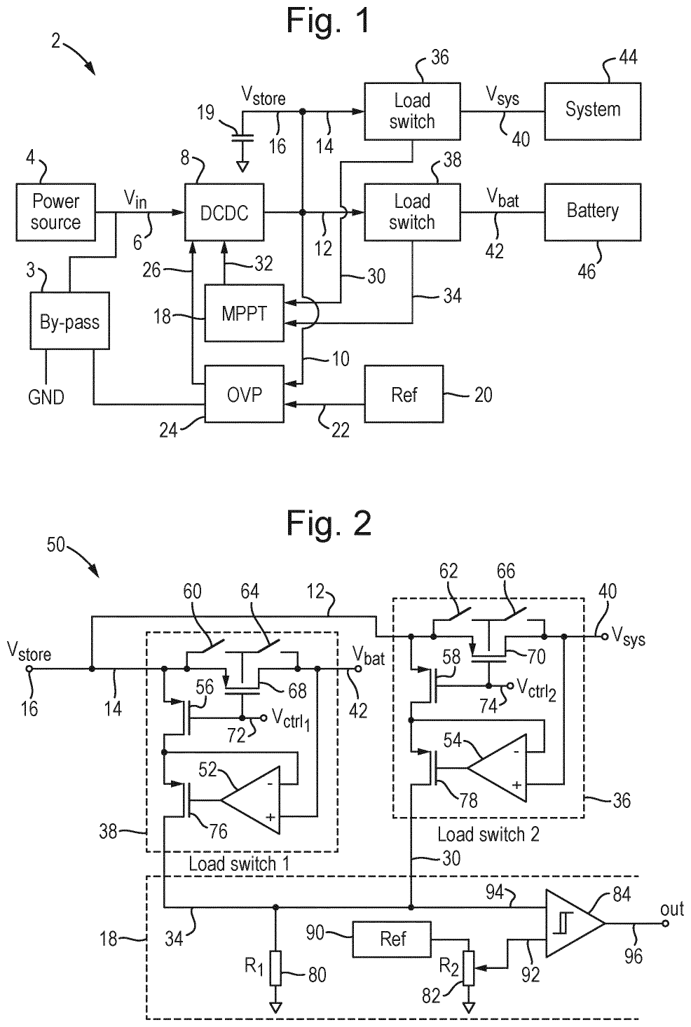

FIG. 1 schematically shows an embodiment of the circuit portion in accordance with the invention; and

FIG. 2 shows in more detail the current-sensing circuit of the circuit portion of FIG. 1.

FIG. 1 is a schematic representation of a circuit 2 embodying the present invention. The circuit 2 supplies two loads 44, 46 with a DC voltage—a system load 44 and a battery 46.

The circuit portion 2 comprises a power source 4 in the form of an energy harvesting device, such as a photovoltaic cell, connected to a DC-DC converter 8. Although not shown in detail, this is a capacitor-based DC-DC converter (i.e. without an inductor) which uses an oscillator to charge and discharge a capacitor to provide the desired output voltage. A number of different configurations could be used—e.g. having multiple capacitors.

The circuit portion 2 includes a voltage-limiting portion comprising a reference voltage source 20 connected to one input 22 of an over voltage protection (OVP) module 24. A second input 10 of the OVP 24 is connected to the output of the DC-DC converter 8. The OVP 24 has an output 26 that is connected to the DC-DC converter 8 for controlling the DC-DC converter 8. Another output of the OVP 24 is connected to a by-pass circuit 3 which can selectively connect the power source 4 to ground. The by-pass circuit 3 could, for example, comprise a switch. Equally the by-pass circuit 3 could be arranged to connect the DC-DC converter 8 to ground.

The circuit portion 2 also includes a current-sensing portion partly provided by two load switches 36, 38, each having a respective input 12, 14 connected in parallel to the DC-DC converter 8 and each having an output 30, 34 respectively, connected to a Maximum Power Point Tracking (MPPT) module 18. Each load switch 36, 38 also has an output 40, 42 connected to a respective load 44, 46 to selectively provide current thereto depending on the status of the switch. A capacitor 19 in parallel with the two load switches 36, 38 allows the value of the voltage at the output of the DC-DC converter 8 to be stored. The MMPT module 18 forms part of the current-sensing portion and has an output 32 connected to the DC-DC converter 8 for controlling certain parameters of the DC-DC converter 8—e.g. the operating frequency of its internal oscillator and its input impedance.

In FIG. 1 the current-sensing circuit comprises two load switches 36, 38, each receiving an input current 12, 14 from the DC-DC converter 8 and each having an output 30, 34 respectively connected to a Maximum Power Point Tracking (MPPT) module 18. Each load switch 36, 38 also has an output 40, 42 connected to a load 44, 46. The MMPT module 18 forms part of the current-sensing circuit and has an output 32 connected to the DC-DC converter 8 for controlling certain parameters of the DC-DC converter. The DC-DC converter 8 further comprises an oscillator (not pictured) which determines its operating frequency.

FIG. 2 shows the current-sensing portion 50 in more detail. A portion of the MPPT module 18 is shown. The two load switches 36, 38 are shown, both of which have the same internal architecture. As mentioned above their respective inputs 14, 12 are connected to the output of the DC-DC converter 8 and thus also connected to the capacitor 19 so that they can receive the stored voltage 16 therefrom. The load switches 40, 38 also each have a control input 72, 74 which receives a control signal from elsewhere on the device. The control voltages (Vctrl₁ or Vctrl₂) provided to these inputs 72, 74 are connected to V_{DD} or ground to open or close the load switches 38, 36, or may be set to a control voltage in a current-limiting configuration. The outputs 42, 44 of the load switches are connected to the battery 46 and system 44 respectively which form the two loads.

Internally the load switches 36, 38 each comprise: an operational transconductance amplifier (OTA) 52, 54; a pass-FET 68, 70; a replica FET 56, 58 and a sense FET 76, 78 which are pMOSFETs in this example. In an alternative implementation, the sense FETs 76, 78 could be nMOSFETs, in which case the polarity of the inputs to the amplifier 52, 54 would be reversed. The pass-FET 68, 70 and the replica FET 56, 58 together provide a non-ohmic semiconductor element. The replica FET56, 58 is scaled down in size relative to the pass FET 68, 70, e.g. by a factor of a thousand. The pass-FET 68, 70 employs bulk switching wherein the source and drain terminals of the pass-FET 68, 70 can be respectively connected to their own bulk terminals via respective switches 60, 64, 62, 66 to ensure that the parasitic p-n junction between the source, drain and bulk connection of each pass-FET 68, 70 are at a high impedance.

The gate of the pass-FET 68 is connected to the gate of the replica FET 56, 58 and the control voltage input 72, 74. The source of the pass-FET 68, 70 is connected to the source of the replica FET 56, 58 and the drain of the replica FET 56, 58 is connected to the source of the sense FET 76, 78. The amplifier 52, 54 has its inverting terminal connected to the drain of the replica FET 56, 58 and the source of the sense FET 76, 78 and its non-inverting terminal connected to the drain of the pass-FET 68, 70. The amplifier 52, 54 has a single-ended output connected to the gate of the sense FET 76, 78.

As well as having an output connected to either the battery 46 or the system load 44, each load switch 38, 36 also has a respective sense current output 34, 30 from each sense FET 76, 78 which flows into a resistor 80 to ground. The voltage across the resistor 80 provides a combined input voltage 94 to a Schmitt-trigger comparator 84. The Schmitt-trigger comparator 84 retains its value until it detects a sufficient change which enables level detection in the circuit. The comparator 84 has its second input 92 connected to a reference voltage source 90 via a variable resistor 82. This allows the voltage representing the currents 34, 30 from the load switches to be compared to a variable reference 92. The output 96 of the comparator 84 is connected to the DC-DC converter 8 via the rest of the MPPT module 18 for adjusting the parameters thereof as shown in FIG. 1.

The operation of the DC-DC supply circuit will now be described with reference to FIGS. 1 and 2.

In overview, the energy harvesting power source 4 produces a current dependent on the amount of light which impinges on it. The current will therefore fluctuate as ambient light levels change. The voltage at which the current is produced is also dependent on other environmental factors such as temperature. The DC-DC converter 8 converts the voltage to a different level appropriate for the loads 40, 42. However the voltage provided by the DC-DC converter may not be sufficiently stable to provide the voltage required to safely charge the battery 46.

Typically, many battery technologies are sensitive to a maximum voltage known in the art per se as the termination voltage. Exceeding this maximum voltage is likely to cause damage to the battery, shortening its useful lifetime or rendering it unusable. Many Li-ion type battery technologies require the maximum supply voltage to be within 1% accuracy, to enable the power supply to fully charge the battery without damaging it. If the supply voltage is not within 1%, approximately 20% of charge could be sacrificed.

The over voltage protection (OVP) module 24 therefore monitors the stored voltage (Vstore) 16 at the capacitor 19, which effectively represents the voltage provided to the battery 46, and disables the DC-DC converter 8 if a suitable voltage is reached. Once the voltage 16 falls to a lower level the DC-DC converter 8 is enabled again. Other implementations may be more complicated than the one shown in FIG. 1. For example, the OVP 24 may gradually change the DC-DC converter 8 operating point to maintain the Vstore voltage 10.

There are many ways that the OVP 24 could control the DC-DC converter 8 based on the sensed voltage. When the OVP 24 determines that the reference voltage 20 has been reached the OVP 24 may send a control signal to the DC-DC converter 8 to reduce its operating frequency by adjusting the parameters of the oscillator in the DC-DC converter 8. Alternatively, the OVP 24 may control the switches 36, 38 to open or become more resistive. The OVP 24 could also route current from the energy harvesting device 4 to ground by means of the by-pass circuit 3, effectively by-passing the DC-DC converter 8.

In addition to possible voltage fluctuations, the amount of power produced by the PV cell 4 and provided at the output of the DC-DC converter 8 depends on the environmental factors and the extent to which the DC-DC converter 8 is matched to the current conditions. In order to take account of this the MPPT module 18 adjusts the input impedance and oscillation frequency of the DC-DC converter 8, based on the output current of the DC-DC converter 8 using an MPPT algorithm, known per se in the art, to ensure that maximum power is extracted from the source 4. This is enabled by the current-sensing portion 50 of FIG. 2.

Turning to FIG. 2 it can be seen that the MPPT module 18 monitors the output current of the DC-DC converter 8 by obtaining a sense current 34, 30 from each load switch 38, 36, assuming that each switch is closed as a result of the respective control input 72, 74 being connected to V_{DD}. It will be noted that the operational transconductance amplifier 52, 54 in each switch is connected across a pair of FETs (i.e. the respective pass-FET 68, 70 and replica FET 56, 58). The arrangement means that the ratio of the sizes—uppermost FETs 56, 68 and 58, 70 respectively, e.g. of 1:1000 causes a sense current 30, 34 to flow into the resistor 80 which is proportional to (i.e. a thousandth of) the current through the pass-FET 68, 70. The paired uppermost FETs 68,56 and 70, 58 are matched, having the same length and same physical orientation on the silicon, but with the replica FET 56, 58 having a width one thousandth of the width of the pass FET 68, 70 so that the above-mentioned current proportional to the current flowing through the pass-FET 68, 70 is made to flow through the replica-FET 56, 58. The resistance between source and drain of the main pass-FET 68,70 is highly temperature, voltage and process dependent. The purpose of the replica-FET 56, 58 is to compensate for this. The source of the replica-FET 56, 58 is connected to the same net and so they share the same voltage. The operational transconductance amplifier (OTA) 52, 54 and pass-FET 76, 78 force the drain of the replica-FET 56, 58 to be at the same voltage as the pass-FET 76, 78.

The sense currents 30, 34 from both switches 38, 36 are effectively summed and converted into a voltage 94 by the resistor 80, which is compared to the reference voltage input 92 by the Schmitt trigger comparator 84 to output a value 96 which is read by the MPPT module 18 and, depending on the value 96, used to adjust the frequency and/or input impedance of the DC-DC converter. More particularly the MPPT module 18 sweeps through a range of values of frequency of the oscillator of the DC-DC converter 8 (or other DCDC control signals) to find the settings for the DC-DC converter 8 that would cause the maximum current to flow to the output 12, 14 as determined by the sense currents 30. 34. Once these are such as to reach a value at the input 94 of the comparator which matches the reference value input 92, the comparator 84 triggers at which point the variable resistor 82 providing the reference input 92 can be stepped up by another increment and the process repeated. It is assumed that the voltage 16 at the DC-DC converter output is reasonably constant so that power delivery can be maximised by maximising the current delivered.

The MPPT module 18 acts to maximise the DC-DC converter 8 output current 12, 14 so that the power delivery from the energy harvesting device 4 is maximised. The arrangement depicted in FIG. 2 effectively acts as a feedback loop so that the MPPT circuit 18 adjusts parameters of the DC-DC converter 8 in order to maximise the current through both switches 36, 38, thereby finding the maximum power point of the energy harvesting source 4—e.g. the PV device, including any losses in the DC-DC converter 8.

As mentioned, when the control voltage (Vctrl₁) provided to the input 72 is connected to ground, the left load switch 38 is enabled and current flows from the output thereof 42 to the battery 46. When this input 72 is connected to V_{DD}, the left load switch 38 is disabled. Similarly, when the control voltage (Vctrl₂) provided to input 74 is connected to ground, the right load switch 36 is enabled and current flows from the output 40 to the system load 44. When this input 74 is connected to V_{DD}, the right load switch 36 is disabled. This therefore allows the device easily to exercise control over powering of the loads.

Alternatively the control inputs 72, 74 can be connected to a controlled voltage in a current-limiting configuration so that a restricted current will be output from either switch 42, 40. For example, if the control voltage provided at the control input 72, 74 were to be decreased, the gate voltage to the pass-FET 68, 70 and the replica FET 56, 58 would be reduced, which would reduce the current flowing between the source and drain terminals of each.

The capacitor 19 connected to the output of the DC-DC converter 8 also allows the device to be started quickly as only the capacitor 19 needs to be charged to an operational voltage 16 which is provided to the load switches rather than the voltage at say the battery 46. Bulk switching is included in the load switches 36, 38 by means of the switches 60, 62, 64, 66 to provide reverse isolation in both directions. As previously described, there is a parasitic p-n junction between the source/drain and bulk connection of the pass-FET 68, 70. The bulk must be at the highest voltage so the parasitic p-n junction remains reverse biased and so no current flows through it. The switching allows the bulk voltage to be chosen so that it is always at the highest voltage relative to the source and drain. This is an optional feature which is more complex in implementation but it means the battery 46 can never be charged unintentionally, even when the storage voltage (Vstore) 16 exceeds the battery voltage (Vbat) 42. Without bulk switching, current in one direction would not be controlled.

It will be appreciated by those skilled in the art that the embodiment set out above allows an inductor-less capacitor-based DC-DC converter, e.g. a switched capacitor DC-DC converter, which does not intrinsically control its output voltage, to be used safely for charging a Li-ion battery 46 from an energy harvesting device which is inherently variable in its output due to its sensitivity to changing environmental conditions. Having a DC-DC converter without an inductor reduces the size and power consumption of the overall circuit.

Therefore, the embodiment described herein combines the advantages of having no inductor—i.e. fewer bulky expensive components—whilst adding value through ensuring that the battery's termination voltage is not exceeded by the energy harvesting power supply.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A circuit portion comprising:
an energy harvesting device producing a DC output;
an inductor-less capacitor-based DC-DC converter, having an input connected to said DC output of the energy harvesting device;
an output connected to a battery;
a voltage limiting module, comprising a voltage sensor arranged to measure a voltage representative of a voltage at the battery;
wherein the voltage limiting module is arranged to limit a voltage provided by the DC-DC converter if said voltage representative of the voltage at the battery exceeds a threshold.

2. The circuit portion as claimed in claim 1, wherein the inductor-less capacitor-based DC-DC converter comprises a plurality of capacitors.

3. The circuit portion as claimed in claim 1, wherein the voltage limiting module further comprises a switch between the DC-DC converter and the battery.

4. The circuit portion as claimed in claim 1, wherein the voltage sensor comprises a comparator with a first input comprising the voltage representing the voltage at the battery and a second input comprising a reference voltage.

5. The circuit portion as claimed in claim 1, wherein the DC-DC converter comprises an oscillator which determines an operating frequency of the DC-DC converter.

6. The circuit portion as claimed in claim 5, wherein the voltage limiting module is configured to reduce the operating frequency of the DC-DC converter based on a measurement obtained by the voltage sensor.

7. The circuit portion as claimed in claim 1 wherein the voltage limiting module is configured to halt operation of the DC-DC converter if the voltage measured by the voltage sensor is above the threshold voltage.

8. The circuit portion as claimed in claim 7, comprising a by-pass circuit arranged to route current from the energy harvesting device or the DC-DC converter to ground if the voltage measured by the voltage sensor is above the threshold voltage.

9. The circuit portion as claimed in claim 1 further comprising a monitoring module arranged to monitor an output current of the DC-DC converter and to adjust one or more parameters of the DC-DC converter based on information relating to the DC-DC converter output current.

10. The circuit portion as claimed in claim 9, wherein the monitoring module is arranged to derive the information relating to the DC-DC converter output current by measuring current through a sense arrangement.

11. The circuit portion as claimed in claim 10, wherein the sense arrangement comprises a non-ohmic semiconductor element.

12. The circuit portion as claimed in claim 9, wherein the one or more parameters of the DC-DC converter comprise an or the operating frequency and/or input impedance.

13. The circuit portion as claimed in claim 9, comprising two or more power paths, wherein said monitoring module is configured to monitor a sum of currents for the two or more power paths.
